(19) United States
(12) Patent Application Publication
(10) Pub. No.: US 2026/0251274 A1
(43) Pub. Date: Aug. 27, 2026

(54) Lantern Post Assemblies Having Reinforcing Post Inserts

(71) Applicant: Walpole Outdoors, Foxborough, MA (US)

(72) Inventor: Samuel D. DeForest, V, North Attleboro, MA (US)

(21) Appl. No.: 19/534,388

(22) Filed: Feb. 9, 2026

Related U.S. Application Data
(60) Provisional application No. 63/755,663, filed on Feb. 7, 2025.

(51) Int. Cl. F21S 8/08

(52) U.S. Cl. CPC F21S 8/088

(57) ABSTRACT

A lantern post assembly having an elongated, hollow outer post, and a reinforcing inner post that is positioned within the outer post is provided. Kits for making the lantern post assembly are also provided. In one preferred embodiment, the reinforcing post includes an interior frame that provides excellent dimensional stability to the lantern post assembly. The lantern post assembly comprising the reinforcing inner post and outer post can be installed in the ground to provide bright and vibrant lighting effects. Furthermore, this construction helps reduce the overall volume of the lantern post assembly and the supplier and customer can save on shipping costs.

### CROSS-REFERENCE TO RELATED APPLICATIONS

The application claims the benefit of U.S. Provisional Patent Application No. 63/755,663 filed Feb. 7, 2025, the entire disclosure of which is hereby incorporated by reference.

### BACKGROUND OF THE INVENTION

### Field of the Invention

The present invention relates generally to lantern post assemblies having reinforcing post inserts. More particularly, the present invention relates to a lantern post assembly having an elongated, hollow outer post, and a reinforcing inner post that is positioned within the outer post. Preferably, the reinforcing post includes an interior frame that provides excellent dimensional stability to the lantern post assembly.

### Brief Review of the Related Art

Support posts are used in a wide variety of assemblies including, but not limited to, lantern, fence, mailbox, patio, and deck building structures. The support posts are generally made from wood, metal, or plastic materials. Lamp fixtures can be mounted on top of the support posts to provide different lighting effects. In recent years, longitudinal support posts containing hollow interior chambers have been used in these assemblies. For example, with lantern post assemblies, a hollow support post is placed into the ground so that it stands upright. The lower end of the support post is anchored in the ground, and the upper end contains a lighting fixture.

In recent years, lantern posts have become more popular and are being used to illuminate a wide variety of areas in residential and commercial areas. Such lantern posts include various lighting systems that provide improved visibility during evening hours and other occasions. For example, lantern posts can be used to light-up walkways, driveways, parking lots, stairways, patios, porches, decks, and the like. Homeowners, guests, delivery persons, and others appreciate lantern posts, because the posts are both decorative and functional. Many lantern posts are aesthetically pleasing and can be used to enhance landscaping and other home or commercial building areas. Lantern posts, when lighting-up walkways, stairways, and the like help to make such areas safer for everyone. However, conventional lantern posts have some drawbacks. For example, it can be cost ineffective for suppliers to ship some conventional lantern posts because of their high shipping volume. Also, some conventional lantern posts have low mechanical strength. Thus, when such lantern posts are anchored into the ground, they can have poor dimensional stability.

There is a need for a lantern post assembly that is commercially feasible to manufacture and cost effective to package and ship to customers. The lantern post assembly should also have good dimensional stability. The present invention provides such a lantern post assembly. Other advantages, features, and benefits of the present invention are described further below.

### SUMMARY OF THE INVENTION

The present invention generally relates to a lantern post assembly. In one preferred embodiment, the lantern post assembly comprises: a) an elongated, upright outer post having a hollow, inside chamber, the outer post having an inside surface and an exterior surface and a top end and a bottom end; b) an elongated, upright reinforcing inner post having an upper portion and a lower portion, wherein the upper portions is positioned within the inside chamber of the outer post, and the lower portion is anchored below a ground surface; and c) a lighting fixture sub-assembly comprising a cap and a housing for a lighting fixture, the lighting fixture sub-assembly being mounted to the top end of the outer post.

The lantern post assembly comprising the reinforcing inner post and outer post can be installed in the ground to provide bright and vibrant lighting effects. Furthermore, this construction helps reduce the overall volume of the lantern post assembly and the supplier and customer can save on shipping costs.

Preferably, the outer post and reinforcing inner post each has a square cross-section and an elongated rectangular shape. The inner and outer posts can have any suitable dimensions. Preferably, the elongated outer post has a length in the range of about 72 inches to about 144 inches, and the reinforcing inner post has a length in the range of about 48 inches to about 84 inches. In one particular embodiment, the elongated, outer post has a length of less than 88 inches, and the reinforcing inner post has a length of 60 inches. In another particular embodiment, the elongated outer post has a length of 77 inches, and the reinforcing inner post has a length of 60 inches. The elongated outer post and reinforcing post can be made of any suitable material such as, for example, polyvinyl chloride. Different lighting fixtures can be mounted on the outer post such as, for example, solar-powered or electrically hardwired fixtures. In one example, the lighting fixture is electrically hardwired, and the reinforcing inner post has an opening in a side panel for wiring.

The present invention further provides kits for a lantern post assembly. In one preferred embodiment, the kit comprises: a) an elongated, outer post having a hollow, inside chamber, the outer post having an inside surface and an exterior surface and a top end and a bottom end; b) an elongated, reinforcing inner post having an upper portion and a lower portion so that the upper portion can be fitted into the inside chamber of the outer post, and the lower portion ca be anchored below a ground surface; and c) a lighting fixture sub-assembly comprising a cap and a housing for a lighting fixture for mounting to the top end of the outer post. The elongated outer post and elongated reinforcing post can be packaged in a first container such as a box and the lighting fixture sub-assembly can be packaged in a second container such as a box for shipment.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a cross-sectional view of one embodiment of a reinforcing inner post of the present invention;

FIG. 2 is a cross-sectional view of one embodiment of a hollow, outer post of the present invention;

FIG. 3 is a cross-sectional view of one embodiment of a lantern post assembly of the present invention showing the reinforcing inner post of FIG. 1 inserted within the hollow outer post of FIG. 2;

FIG. 4A is a perspective view of one embodiment of a lantern post assembly of the present invention showing the reinforcing inner post of FIG. 1 inserted within the hollow outer post of FIG. 2;

FIG. 4B is a close-up view of lantern post assembly of FIG. 4 showing the reinforcing inner post of FIG. 1 being inserted within the hollow outer post of FIG. 2;

FIG. 5A is a perspective view of one embodiment of packaging for a lantern post assembly of the present invention;

FIG. 5B is a perspective view of one embodiment of packaging for a lighting fixture for the lantern post assembly of FIG. 5A;

FIG. 6A is a perspective view of one embodiment of a lantern post assembly of the present invention showing the lantern post assembly in an upright position;

FIG. 6B is a perspective view of one embodiment of the lantern post assembly of

FIG. 6A showing the lantern post assembly in a package for shipment; and

FIG. 6C is a perspective view of one embodiment of a lantern post assembly of

FIG. 6A showing the lantern post assembly installed in the ground.

### DETAILED DESCRIPTION OF THE INVENTION

The following description primarily refers to a lantern post assembly, but it should be understood that any suitable assembly including, but not limited to, lantern, fence, mailbox, patio, and deck building structures, can be manufactured in accordance with the present invention. Referring to the Figures, one embodiment of a lantern post assembly of the present invention is shown.

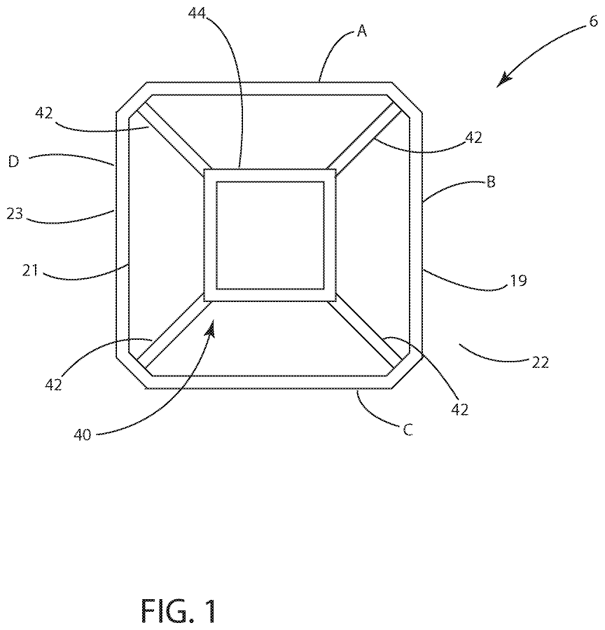

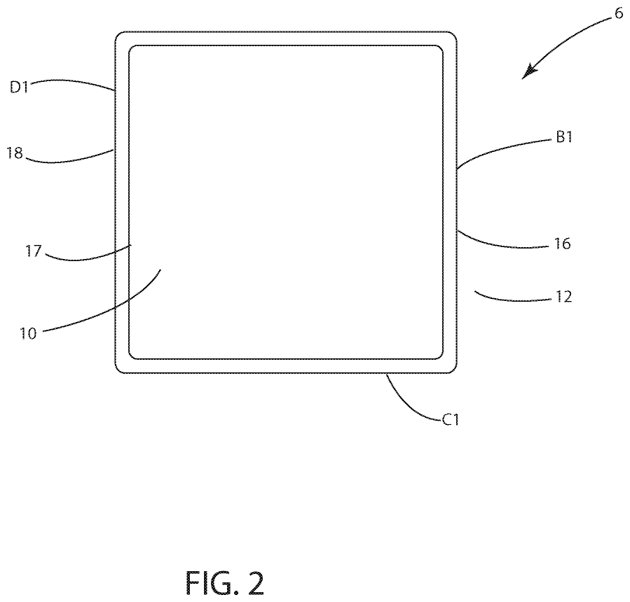

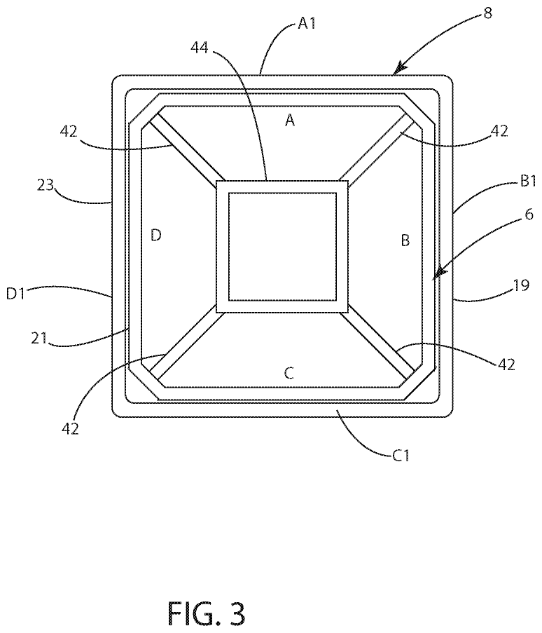

As illustrated in the Figures, the lantern post assembly of the present invention is made of separate and distinct component parts that can be assembled and disassembled easily. More particularly, the lantern post assembly comprises: a) an elongated, hollow outer post; and b) a reinforcing inner post that is positioned within the outer post. Referring to FIG. 1, one embodiment of the inner post (6) used to fabricate the lantern post assembly of the present invention is shown. In FIG. 2, one embodiment of the outer post (8) used to fabricate the lantern post assembly of the present invention is shown. The reinforcing inner post (6) is structured so that it can be fitted into the hollow chamber (10) of the outer post (8) as shown in FIG. 3 and discussed further below.

More particularly, the elongated, hollow, outer post (8) has a first (top) end (12) and an opposing second (bottom) end (14) with four side walls (16) extending from the top end (12) to the bottom end (14). As shown in FIG. 2, the four surrounding side walls (16) have inside (17) and outside (18) surfaces to define a hollow interior chamber (10) for receiving the reinforcing inner post (6). That is, the reinforcing inner post (6) is inserted into the hollow chamber (10) of the outer post (8) when the lantern post is assembled.

The elongated, reinforcing inner post (6) has an upper portion (22) and a lower portion (24). There are four side walls (19) extending from the upper portion (22) to the lower portion (24). As shown in FIG. 1, the four surrounding side walls (19) have inside (21) and outside (23) surfaces. The reinforcing inner post preferably includes an interior frame (40) having arm segments (42) that radiated outwardly as discussed further below. In one preferred embodiment, as shown in FIGS. 1-3, the inner (6) and outer (8) posts have generally square cross-sectional shapes that are complementary to each other. However, it is recognized that the inner (6) and outer (8) posts can have any suitable cross-sectional shape such as, for example, circular, oval, triangular, square, diamond, pentagonal, hexagonal, heptagonal, octagonal, and the like.

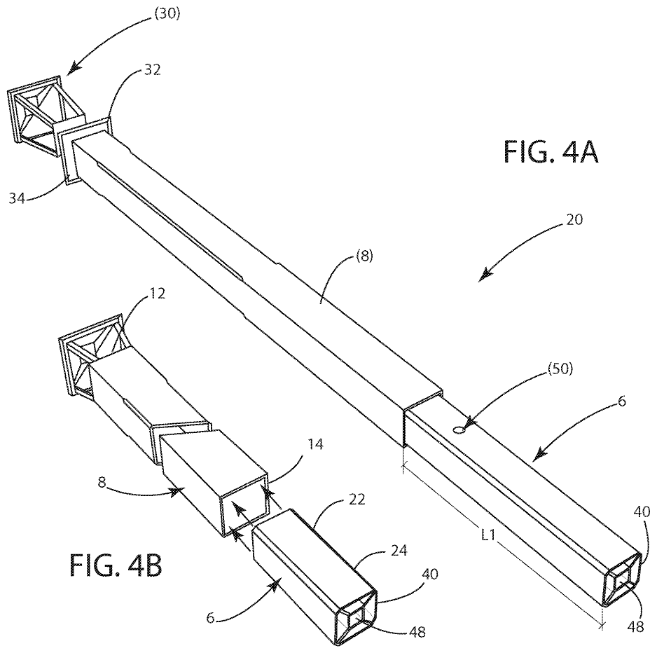

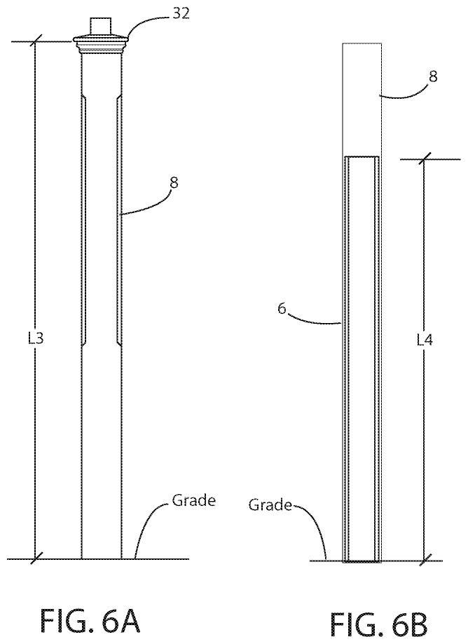

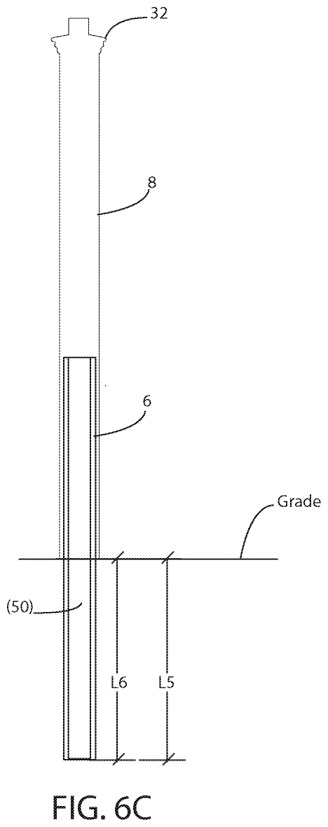

Referring to FIG. 4A, and 4B, one embodiment of a lantern post assembly, as generally indicated at (20), of the present invention is shown. The lantern post assembly (20) includes the elongated, outer post (8) having the hollow chamber (10); and the elongated reinforcing inner post (6) positioned inside of the outer post (8). In FIG. 4A, and 4B, the lower portion (24) of the inner post (6) is shown extending outwardly from the outer post (8) with length (L1). As shown in FIG. 6C and discussed further below, when the lantern post assembly (20) is installed in the ground, the lower portion (24) will be anchored below the ground surface (grade). The lantern post assembly (20) further includes a lighting fixture sub-assembly (30) comprising a cap (32) and a housing (34) for a lighting fixture that is mounted to the upper end (12) of the outer post (8). The housing (34) can contain any suitable lighting fixture and system such as, for example, a solar-powered or electrically, hardwired system. In one example, as shown in FIG. 4A, the lighting fixture is electrically hardwired, and the reinforcing inner post has an opening (50) in a side panel for wiring,

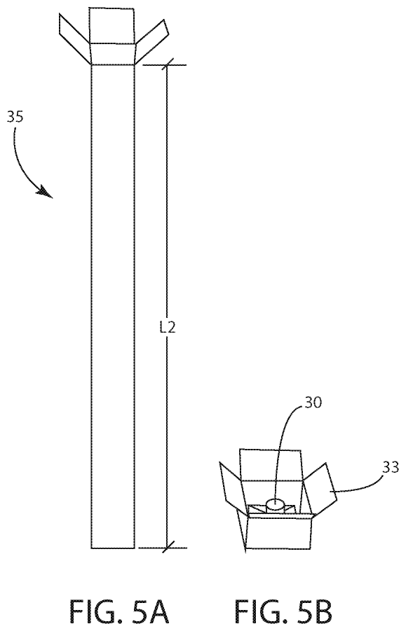

Referring to FIG. 5A, and 5B, the lantern post assembly (20) of the present invention can be easily packaged, stored, and transported. For example, the reinforcing inner post (6) can first be placed within the hollow, outer post (8). The pre-assembly kit for the lantern post assembly, comprising: a) the reinforcing inner post (6) and b) the elongated, outer post (8) has an upper portion (22) and a lower portion (24) is now ready for shipping as shown in FIG. 5A. The pre-assembly lantern post kit can be loaded in a box or other suitable container (35) having a length (L2), and the supplier can ship the box to a customer. The lighting fixture sub-assembly (30) can be packaged and shipped in a separate box (33) as shown in FIG. 5B. One advantage of the present invention is the length of the inner and outer posts (6, 8). As discussed further below, when the length of the outer post is 6′6″ (80 inches) as shown, for example, in FIG. 5A, the supplier can save on shipping costs when packaging and shipping the pre-assembly lantern post kit to a customer. When the customer receives the package (35), he/she can remove the component parts in the kit and easily assemble the lantern post assembly (20).

When the lantern post (20) needs to be assembled, the customer removes the different parts and pieces them together. Preferably the components of the lantern post assembly (20) are assembled before placing the post assembly in the ground. As discussed above, the lantern post comprising the reinforcing inner post (6) and outer post (8) can be packaged together and shipped to a customer as shown in FIG. 5A. The lighting fixture sub-assembly (30) can be packaged and shipped in a separate box as shown in FIG. 5B. In other embodiments, the lighting fixture sub-assembly (30) can be shipped in the same box as the reinforcing inner post (6) and outer post (8). After the different parts have been assembled, the lower portion (24) of the reinforcing inner post (6) can be anchored in the ground. Cement, dirt, or other suitable material can be used to anchor the reinforcing inner post (6) so that it stands upright and straight. As discussed above, the reinforcing inner post (6) is positioned within the outer post (8), and the outer post (8) also extends upwardly. The vertically, upright reinforcing inner post (6) fits tightly within the vertically, upright outer post (8). A person can also easily disassemble the lantern post assembly (20) if needed.

The component inner and outer posts (6,8) of the lantern post assembly (20) can be made of any suitable material including, for example, metals, wood, and plastics. However, as discussed further below, it is important that the outer post (8) has a hollow inside chamber (10). In one preferred embodiment, the elongated outer post (8) and reinforcing inner post (6) are made of a plastic vinyl material such as polyvinyl chloride (PVC).

The elongated, hollow upright outer post (8) is typically made of a four-inch by four-inch square or five-inch by five-inch square beam. The outer post generally has a length in the range of about 6 feet (72 inches) to about 12 feet (144 inches) and preferably less than 7′4″ (88 inches) as discussed further below.

As discussed above, the reinforcing inner post (6) is an elongated beam, and it is positioned within the chamber (10) of the hollow outer post (8). The reinforcing inner post (6) provides an interior support piece for the outer post (8). Turning back to FIG. 1, in one embodiment, the reinforcing inner post (6) generally has a square cross-section and an elongated rectangular shape with an upper portion (22) and a lower portion (24). There are four side walls (19) indicated as A, B, C, and D panels extending along the length of the inner post (6). Each of the side panels (A, B, C, and D) have the same length and width and are joined to each other to form a reinforcing inner post (6) having a generally elongated, rectangular shape. The corners, where the four side panels (A, B, C, and D) are joined together can be rounded as shown in FIG. 1.

Turning back to FIG. 2, in one embodiment, the hollow outer post generally has a square cross-section and an elongated rectangular shape with a first (top) end (12) and a second (bottom) end (14). There are four side walls (16) indicated as A1, B1, C1, and D1 panels extending along the length of the outer post (8). Each of the side panels (A1, B1, C1, and D1) have the same length and width and are joined to each other to form an outer post (8) having a generally elongated, rectangular shape. The corners, where the four side panels (A1, B1, C1, and D1) are joined together can be rounded as shown in FIG. 2.

In accordance with the present invention, the reinforcing inner post (6) can be inserted into the elongated, hollow outer post (8) during assembly. The reinforcing inner post (6) slides into and fits tightly within the hollow outer post (8), that is, there is a close tolerance between the two pieces, and the fitting is similar to a “snap-fit.” The upper portion (22) of the reinforcing inner post (6) is fitted tightly within the inside chamber (10) of the outer post (8). The lower portion (24) of the reinforcing inner post (6) projects outwardly from the outer post (8). When installed into the ground, the reinforcing inner post (6) is anchored below the ground surface (grade) using cement, dirt, or other suitable material.

One advantage of the present invention is the length of the inner (6) and outer (8) posts. As discussed above, the inner (6) and outer (8) posts can have any suitable dimensions. The outer post (8) generally has a length in the range of about 6 feet (72 inches) to about 12 feet (144 inches) and preferably less than 7′4″ (88 inches). When the length of the outer post (8) is less than 7′4″ (88 inches), the supplier can save on shipping costs when packaging and shipping the lantern post pre-assembly (20) to a customer. In one preferred embodiment, the outer post (8) has a length (L3) of about 6′5″ (77 inches) as shown in FIG. 6A. Meanwhile, the reinforcing inner post (6), in the present invention, generally has a length (L4) in the range of about 4 feet (48 inches) to about 7 feet (84 inches) and preferably has a length (L5) of about 5 feet (60 inches) as shown in FIG. 6B. When the lantern post assembly (20) is constructed, and a 60-inch length reinforcing inner post (6) is used, it will slide into the hollow outer post (8) so that about a 30-inch length of the inner post (6) is fitted within the hollow chamber (10) of the outer post (8). As shown in FIG. 6C, the remaining 30-inch length (L5) of the inner post (6) can be anchored in the ground. As also shown in FIG. 6C and FIG. 4A, the lighting fixture can be s electrically hardwired, and the reinforcing inner post (6) can have an opening (50) for the wiring, wherein the opening is distanced (L6) from the lower end of the reinforcing post (6). The reinforcing inner post (6) provides excellent dimensional-stability and support to the lantern post assembly (20) as discussed further below.

Referring back to FIG. 1, in one particularly preferred embodiment, the reinforcing inner post (6) includes an interior frame generally indicated at (40). The interior frame (40) includes arm segments (42) that radiate outwardly from a central connector column (44) to the side panels (A, B, C, and D) of the reinforcing inner post (6). The central connector column (44) is preferably an elongated, hollow, rectangular shaped structure. That is, the central connector column (44) has a first (upper) end (46) and an opposing second (lower) end (48). There are four side panels extending from the upper end (46) to the lower end (48) of the central connector column (44).

As shown in FIG. 1, in one preferred embodiment of the interior frame (40), there are four radial arm segments (42) that extend outwardly from the four corners of the elongated, rectangular-shaped central connector column (44). In one preferred embodiment, the reinforcing inner post (6) and interior frame (40) are a one-piece integral unit. The reinforcing inner post (6) and interior frame (40) can be integrally molded to form a unitary piece. In another embodiment, the interior frame (40) includes transverse arm segments that extend horizontally from one side panel to an opposing second side panel. The reinforcing inner post (6) can have other suitable interior frame (40) cross-sections in accordance with the invention. The inner post (6) with its interior frame helps to reinforce and support the outer post (8). The inner post (6) enhances the mechanical strength and durability of the lantern post assembly (20).

The lantern post assembly of the present invention provides several advantages. For example, as discussed above, the lantern post assembly preferably includes an outer post having a length less than 7′4″ (88 inches) and a reinforcing inner post having a length of about 5′ (60 inches). This construction helps reduce the overall volume of the lantern post assembly and the supplier and customer can save on shipping costs. Additionally, as also described above, the preferred square cross-section of the post means the relatively thin wall of the hollow outer post and the relatively thin wall of the reinforcing inner post are combined to effectively form a strong double-wall protection. The lantern post assembly comprising the reinforcing inner post and outer post can be installed in the ground to provide bright and vibrant lighting effects. Furthermore, this construction helps reduce the overall volume of the lantern post assembly and the supplier and customer can save on shipping costs.

It should be understood that the terms, “first”, “second”, “top”, “bottom”, “upper”, “lower”, “upwardly”, “downwardly”, “above” “below”, “right”, “left”, and the like are arbitrary terms used to refer to one position of an element based on one perspective and should not be construed as limiting the scope of the invention.

It also should be understood that the assemblies, sub-assemblies, kits, materials, constructions, and the like described and illustrated herein represent only some embodiments of the invention. It is appreciated by those skilled in the art that various changes and additions can be made to the assemblies, sub-assemblies, kits, materials, and constructions and the like without departing from the spirit and scope of this invention. It is intended that all such embodiments be covered by the appended claims.

I claim:

1. A lantern post assembly, comprising;
an elongated, upright outer post having a hollow, inside chamber, the outer post having an inside surface and an exterior surface and a top end and a bottom end;
an elongated, upright reinforcing inner post having an upper portion and a lower portion, wherein the upper portions is positioned within the inside chamber of the outer post, and the lower portion is anchored below a ground surface; and
a lighting fixture sub-assembly comprising a cap and a housing for a lighting fixture, the lighting fixture sub-assembly being mounted to the top end of the outer post.

2. The lantern post assembly of claim 1, wherein the outer post and reinforcing inner post each has a square cross-section and an elongated rectangular shape.

3. The lantern post assembly of claim 2, wherein the elongated outer post has a length in the range of about 72 inches to about 144 inches, and the reinforcing inner post has a length in the range of about 48 inches to about 84 inches.

4. The lantern post assembly of claim 3, wherein the elongated outer post has a length of less than 88 inches, and the reinforcing inner post has a length of 60 inches.

5. The lantern post assembly of claim 3, wherein the elongated outer post has a length of 77 inches, and the reinforcing inner post has a length of 60 inches.

6. The lantern post assembly of claim 1, wherein the elongated outer post and reinforcing post are made of polyvinyl chloride.

7. The lantern post assembly of claim 1, wherein the lighting fixture is solar-powered or electrically hardwired.

8. The lantern post assembly of claim 1, wherein the lighting fixture is electrically hardwired, and the reinforcing inner post has an opening in a side panel for wiring.

9. A kit for a lantern post assembly, the kit comprising:
an elongated, outer post having a hollow, inside chamber, the outer post having an inside surface and an exterior surface and a top end and a bottom end;
an elongated, reinforcing inner post having an upper portion and a lower portion so that the upper portion can be fitted into the inside chamber of the outer post, and the lower portion ca be anchored below a ground surface; and
a lighting fixture sub-assembly for mounting to the top end of the outer post, the lighting fixture sub-assembly comprising a cap and a housing for a lighting fixture.

10. The kit of claim 9, wherein the elongated outer post and elongated reinforcing post are packaged in a first container and the lighting fixture sub-assembly is packaged in a second container for shipment.
